(19) United States
(12) Patent Application Publication
(10) Pub. No.: US 2004/0126498 A1
(43) Pub. Date: Jul. 1, 2004

(54) Grinding paint of a decoration bulb and method of painting the decoration bulb

(76) Inventor: Cheng-Gui Lu, Taichung (TW)

Correspondence Address: Charles E. Baxley, Hart, Baxley, Danicls & Holton, Suite 309, 90 John Street, New York, NY, 10038, US

(21) Appl. No.: 10/330,801

(22) Filed: Dec. 25, 2002

(51) Int. Cl. B05D 3/02

(52) U.S. Cl. 427/386

(57) ABSTRACT

A grinding paint has 30% to 45% of a copolymer of melamine, sulphonamide and formaldehyde, 30% to 45% of a resin, 20% to 30% of a solvent, 1% to 3% of a transparent paint, and 0.5% to 1.5% of an assistant agent. The resin is selected from a group consisting of epoxy resin, alkyd resin, amino-compound resin, and acrylic resin. The solvent is selected from a group consisting of alcohols, ketones, and aromatic compounds. The transparent paint is a metal-containing powder dissolved in the solvent to form a transparent liquid. The assistant agent is a silicon-containing liquid. The grinding paint is painted on a decoration bulb by spraying, dipping or showering to form a base coating layer on the decoration bulb. The base coating layer is baked at 150° C. to 250° C. for approximately ten to fifteen minutes.

### BACKGROUND OF THE INVENTION

The present invention relates to a grinding paint of a decoration bulb. More particularly, the present invention relates to a method of painting the decoration bulb.

A conventional method of grinding paint on an inner surface of a decoration bulb contains daubing a chemical agent such as a fluoride, a fluoric acid and a sulphuric acid on the inner surface of the decoration bulb. However, it is cumbersome to daub the chemical agent on the inner surface of the decoration bulb. Furthermore, the chemical agent will pollute an environment. The ozone layer of the atmosphere will be destroyed by the fluoride and the fluoric acid. The fluoric acid and the sulphuric acid will injure a health of a worker. Since a mechanical strength of the decoration bulb is weakened by fluorides, the fluoric acid and the sulphuric acid, the decoration bulb is broken while transporting.

### SUMMARY OF THE INVENTION

An object of the present invention is to provide a grinding paint of a decoration bulb in order to reduce a chemical pollution to an environment.

Another object of the present invention is to provide a grinding paint of a decoration bulb and method of painting the decoration bulb in order to produce an excellent refraction effect.

Another object of the present invention is to provide a grinding paint of a decoration bulb and method of painting the decoration bulb in order to form a coating layer on the decoration bulb so that an impact failure of the decoration bulb will be reduced and a mechanical strength of the decoration bulb will be increased.

Accordingly, a grinding paint comprises 30% to 45% of a copolymer of melamine, sulphonamide and formaldehyde, 30% to 45% of a resin, 20% to 30% of a solvent, 1% to 3% of a transparent paint, and 0.5% to 1.5% of an assistant agent.

Another grinding paint comprises 30% to 45% of a main component selected from a group consisting of barium sulfate, calcium carbonate, talc powder, and mica powder, 30% to 45% of a resin, 20% to 30% of a solvent, 1% to 3% of a transparent paint, and 0.5% to 1.5% of an assistant agent.

### DETAILED DESCRIPTION OF THE INVENTION

A grinding paint comprises 30% to 45% of a copolymer of melamine, sulphonamide and formaldehyde, 30% to 45% of a resin, 20% to 30% of a solvent, 1% to 3% of a transparent paint, and 0.5% to 1.5% of an assistant agent.

The resin is selected from a group consisting of epoxy resin, alkyd resin, amino-compound resin, and acrylic resin.

The solvent is selected from a group consisting of alcohols, ketones, and aromatic compounds.

The transparent paint is a metal-containing powder which is dissolved in the solvent to form a transparent liquid.

The assistant agent is a silicon-containing liquid to smooth the grinding paint and to remove bubbles.

The grinding paint is painted on a decoration bulb by spraying, dipping or showering to form a base coating layer on the decoration bulb. The grinding paint is transparent.

The base coating layer is baked at 150° C. to 250° C. for approximately ten to fifteen minutes.

It is an option that the decoration bulb is a green bulb.

It is an option to paint a transparent paint on the base coating layer. The transparent paint is baked at 150° C. to 250° C. for approximately ten to fifteen minutes.

The decoration bulb has a smooth surface in order to produce a special refraction effect. Since the base coating layer on the decoration bulb will strengthen a mechanical strength of the decoration bulb, an impact failure of the decoration bulb will be reduced and the mechanical strength of the decoration bulb will be increased. Furthermore, the present invention will reduce a chemical pollution to an environment and increase a production effeciency in order to reduce a production cost.

A first preferred embodimnet of the present invention is described as follows. The grinding paint is sprayed on a green decoration bulb to form a base coating layer on the green decoration bulb. The base coating layer is baked at 160° C. for approximately fifteen minutes. The green decoration bulb has a smooth surface and a filament cannot be seen from outside while lightening. A mechanical strength of the green decoration bulb of the present invention is better than a mechanical strength of a conventional green decoration bulb.

A second preferred embodimnet of the present invention is described as follows. The grinding paint is sprayed on a green decoration bulb to form a base coating layer on the green decoration bulb. A transparent paint is showered on the base coating layer. The transparent paint and the base coating layer are baked at 160° C. for approximately twelve minutes. The transparent paint will form a transparent film to refract light, so light will be focused in the green decoration bulb to produce a three dimension light effect. The green decoration bulb has a smooth surface and a filament cannot be seen from outside while lightening. A mechanical strength of the green decoration bulb of the present invention is better than a mechanical strength of a conventional green decoration bulb.

A third preferred embodimnet of the present invention is described as follows. The grinding paint is dipped on a green decoration bulb to form a base coating layer on the green decoration bulb. The base coating layer is baked at 240° C. for approximately ten minutes. A transparent paint is showered on the base coating layer. The transparent paint is baked at 150° C. for approximately fifteen minutes. The transparent paint will form a transparent film to refract light, so light will be focused in the green decoration bulb to produce a three dimension light effect. The green decoration bulb has a smooth surface and a filament cannot be seen from outside while lightening. A mechanical strength of the green decoration bulb of the present invention is better than a mechanical strength of a conventional green decoration bulb.

Another grinding paint comprises 30% to 45% of a main component selected from a group consisting of barium sulfate, calcium carbonate, talc powder, and mica powder, 30% to 45% of a resin, 20% to 30% of a solvent, 1% to 3% of a transparent paint, and 0.5% to 1.5% of an assistant agent.

The resin is selected from a group consisting of epoxy resin, alkyd resin, amino-compound resin, and acrylic resin.

The solvent is selected from a group consisting of alcohols, ketones, and aromatic compounds.

The transparent paint is a metal-containing powder which is dissolved in the solvent to form a transparent liquid.

The assistant agent is a silicon-containing liquid.

The invention is not limited to the above embodiment but various modification thereof may be made. Further, various changes in form and detail may be made without departing from the scope of the invention.

I claim:

1. A grinding paint comprises:
30% to 45% of a copolymer of melamine, sulphonamide and formaldehyde,
30% to 45% of a resin,
20% to 30% of a solvent,
1% to 3% of a transparent paint, and
0.5% to 1.5% of an assistant agent.

2. The grinding paint as claimed in claim 1, wherein the resin is selected from a group consisting of epoxy resin, alkyd resin, amino-compound resin, and acrylic resin, the solvent is selected from a group consisting of alcohols, ketones, and aromatic compounds, the transparent paint is a metal-containing powder dissolved in the solvent to form a transparent liquid, and the assistant agent is a silicon-containing liquid.

3. A grinding paint comprises:
30% to 45% of a main component selected from a group consisting of barium sulfate, calcium carbonate, talc powder, and mica powder,
30% to 45% of a resin,
20% to 30% of a solvent,
1% to 3% of a transparent paint, and
0.5% to 1.5% of an assistant agent.

4. The grinding paint as claimed in claim 3, wherein the resin is selected from a group consisting of epoxy resin, alkyd resin, amino-compound resin, and acrylic resin, the solvent is selected from a group consisting of alcohols, ketones, and aromatic compounds, the transparent paint is a metal-containing powder dissolved in the solvent to form a transparent liquid, and the assistant agent is a silicon-containing liquid.

5. A method of painting a grinding paint on a decoration bulb comprises:
the grinding paint painted on the decoration bulb by spraying, dipping and showering to form a base coating layer on the decoration bulb,
the base coating layer baked at 150° C. to 250° C. for approximately ten to fifteen minutes,
the grinding paint comprising 30% to 45% of a copolymer of melamine, sulphonamide and formaldehyde, 30% to 45% of a resin, 20% to 30% of a solvent, 1% to 3% of a transparent paint, and 0.5% to 1.5% of an assistant agent.

6. The grinding paint as claimed in claim 5, wherein the resin is selected from a group consisting of epoxy resin, alkyd resin, amino-compound resin, and acrylic resin, the solvent is selected from a group consisting of alcohols, ketones, and aromatic compounds, the transparent paint is a metal-containing powder dissolved in the solvent to form a transparent liquid, and the assistant agent is a silicon-containing liquid.

7. A method of painting a grinding paint on a green decoration bulb comprises:
the grinding paint painted on the green decoration bulb by spraying, dipping and showering to form a base coating layer on the green decoration bulb,
the base coating layer baked at 150° C. to 250° C. for approximately ten to fifteen minutes,
the grinding paint comprising 30% to 45% of a copolymer of melamine, sulphonamide and formaldehyde, 30% to 45% of a resin, 20% to 30% of a solvent, 1% to 3% of a transparent paint, and 0.5% to 1.5% of an assistant agent.

8. The grinding paint as claimed in claim 7, wherein the resin is selected from a group consisting of epoxy resin, alkyd resin, amino-compound resin, and acrylic resin, the solvent is selected from a group consisting of alcohols, ketones, and aromatic compounds, the transparent paint is a metal-containing powder dissolved in the solvent to form a transparent liquid, and the assistant agent is a silicon-containing liquid.

9. A method of painting a grinding paint on a green decoration bulb comprises:
the grinding paint painted on the green decoration bulb by spraying, dipping and showering to form a base coating layer on the green decoration bulb,
the base coating layer baked at 150° C. to 250° C. for approximately ten to fifteen minutes,
a transparent paint painted on the base coating layer,
the transparent paint baked at 150° C. to 250° C. for approximately ten to fifteen minutes,
the grinding paint comprising 30% to 45% of a copolymer of melamine, sulphonamide and formaldehyde, 30% to 45% of a resin, 20% to 30% of a solvent, 1% to 3% of a transparent paint, and 0.5% to 1.5% of an assistant agent.

10. The grinding paint as claimed in claim 9, wherein the resin is selected from a group consisting of epoxy resin, alkyd resin, amino-compound resin, and acrylic resin, the solvent is selected from a group consisting of alcohols, ketones, and aromatic compounds, the transparent paint is a metal-containing powder dissolved in the solvent to form a transparent liquid, and the assistant agent is a silicon-containing liquid.
